(19) United States
(12) Patent Application Publication
(10) Pub. No.: US 2021/0251269 A1
(43) Pub. Date: Aug. 19, 2021

(54) Beverages Comprising Highly Soluble Steviol Glycoside Blend and Glucosylated Steviol Glycosides

(71) Applicant: The Coca-Cola Company, Atlanta, GA (US)

(72) Inventors: Youlung Chen, Marietta, GA (US); Juvenal Higiro, Atlanta, GA (US); Indra Prakash, Alpharetta, GA (US); Gil Ma, Atlanta, GA (US); Yuongsuk Heo, Cumming, GA (US); Yu Shi, Marietta, GA (US)

(21) Appl. No.: 17/251,535

(22) PCT Filed: Jun. 12, 2019
(86) PCT No.: PCT/US2019/036689

§ 371 Date: Dec. 11, 2020

Related U.S. Application Data
(60) Provisional application No. 62/684,463, filed on Jun. 13, 2018.

(51) Int. Cl. A23L 27/30; A23L 2/60; A23L 33/00

(52) U.S. Cl. CPC A23L 27/33; A23L 33/30; A23L 2/60

(57) ABSTRACT

Steviol glycoside blends comprising rebaudioside A, rebaudioside M, rebaudioside D and rebaudioside B that have aqueous solubility at relevant beverage concentrate concentrations are provided herein. Blends comprising steviol glycoside blends of the present invention and compositions comprising glucosylated steviol glycosides are also provided. Beverage syrups and beverages made from these blends are also provided.

### CROSS REFERENCE TO RELATED APPLICATION

The present application claims priority to U.S. Provisional Application No. 62/684,463, filed Jun. 13, 2018, the content of which is hereby incorporated by reference.

### FIELD OF THE INVENTION

The present invention relates generally to beverages comprising blends of rebaudioside B, rebaudioside D, rebaudioside M, rebaudioside A and glucosylated steviol glycosides.

### BACKGROUND OF THE INVENTION

Natural caloric sugars, such as sucrose, fructose and glucose, are utilized to provide a pleasant taste to beverages, foods, pharmaceuticals, and oral hygienic/cosmetic products. Sucrose, in particular, imparts a taste preferred by consumers. Although sucrose provides superior sweetness characteristics, it is disadvantageously caloric.

Non-caloric or low caloric sweeteners have been introduced to satisfy consumer demand. However, non- and low caloric sweeteners taste different from natural caloric sugars in ways that frustrate consumers. On a taste basis, non-caloric or low caloric sweeteners exhibit a temporal profile, maximal response, flavor profile, mouth feel, and/or adaptation behavior that differ from sugar. Specifically, non-caloric or low caloric sweeteners exhibit delayed sweetness onset, lingering sweet aftertaste, bitter taste, metallic taste, astringent taste, cooling taste and/or licorice-like taste. On a source basis, many non-caloric or low caloric sweeteners are synthetic chemicals. Consumer desire for natural non-caloric or low caloric sweeteners that tastes like sucrose remains high.

Stevia rebaudiana Bertoni is a perennial shrub of the Asteraceae (Compositae) family native to certain regions of South America. Its leaves have been traditionally used for hundreds of years in Paraguay and Brazil to sweeten local teas and medicines. The plant is commercially cultivated in Japan, Singapore, Taiwan, Malaysia, South Korea, China, Israel, India, Brazil, Australia and Paraguay.

The leaves of the plant contain a mixture containing diterpene glycosides in an amount ranging from about 10% to 15% of the total dry weight. These diterpene glycosides are about 30 to 450 times sweeter than sugar. Structurally, the diterpene glycosides are characterized by a single base, steviol, and differ by the presence of carbohydrate residues at positions C13 and C19. Typically, on a dry weight basis, the four major steviol glycosides found in the leaves of Stevia are dulcoside A (0.3%), rebaudioside C (0.6-1.0%), rebaudioside A (3.8%) and stevioside (9.1%).

A concentration of at least 0.25% (% w/w) is useful for beverage syrups. Syrups having such concentrations can readily be diluted to beverages. However, a number of steviol glycosides have poor aqueous solubility and cannot be formulated into beverage syrups without use of additives, heat and/or special equipment. For example, the aqueous solubility of Rebaudioside B, Rebaudioside D and Rebaudioside M is from about 0.05-0.1% wt %. Rebaudioside A has an aqueous solubility of about 0.8 wt %.

Accordingly, there remains a need to develop steviol glycoside sweeteners with improved solubility at relevant beverage concentrate concentrations.

### SUMMARY OF THE INVENTION

In one aspect, the present invention provides ternary and quaternary steviol glycoside blends.

In one embodiment, a quaternary steviol glycoside blend comprises from about 26% to about 35% rebaudioside A by weight, from about 40% to about 49% rebaudioside M by weight, from about 15% to about 25% rebaudioside B by weight and from about 5% to about 15% rebaudioside D by weight.

In another embodiment, a ternary steviol glycoside blend comprises from about 26% to about 35% rebaudioside B by weight, from about 10% to about 15% rebaudioside D by weight and from about 55% to about 60% rebaudioside M by weight.

In still another embodiment, a ternary steviol glycoside blend comprises from about 26% to about 35% rebaudioside A by weight, from about 15% to about 25% rebaudioside B by weight and from about 40% to about 60% rebaudioside M by weight.

The steviol glycoside blends of the present invention are advantageously soluble at room temperature at relevant beverage syrup concentrations (e.g. from about 0.25 wt % to about 0.35% or about 0.4 wt %) used to prepare, e.g. carbonated beverages. In a particular embodiment, the steviol glycoside blends of the present invention exhibit superior aqueous solubility at such concentrations at room temperature compared to beverages comprising a steviol glycoside mixture of reb M, e.g. reb M 95%.

Methods of preparing the steviol glycoside blends of the present invention by spray-drying are also provided. Steviol glycoside blends so-prepared have aqueous solubilties of at least about 3 wt %.

In another aspect, the present invention provides a blend comprising a steviol glycoside blend described herein and a composition comprising GSG, wherein the blend provides superior sensory properties when formulated into a beverage compared to a corresponding beverage formulated without the composition comprising GSG.

In still another aspect, the present invention provides a beverage concentrate comprising a steviol glycoside blend described herein and a composition comprising GSG, wherein the concentrate has a concentration of at least about 0.25 wt % steviol glycosides and is clear by visual inspection.

In yet another aspect, the present invention provides a beverage comprising (i) a steviol glycoside blend of the present invention and (ii) a composition comprising GSG, wherein the steviol glycoside concentration is from about 50 ppm to about 600 ppm and the composition comprising GSG concentration is from about 5 ppm to about 50 ppm.

Beverages of the present invention have at least about 8% sucrose equivalence. The beverage can be a zero-, mid- or full-calorie beverage, preferably a zero-calorie beverage. The beverage can be carbonated or non-carbonated, preferably carbonated.

### DETAILED DESCRIPTION OF THE INVENTION

### I. Definitions

“Purity” as used herein, refers to the dry weight of the steviol glycoside of interest, e.g. rebaudioside B, with respect to the dry weight of a mixture containing the steviol glycoside prior to preparation of the steviol glycoside blend.

“Syrup” or “Beverage syrup”, as used herein, refers to a beverage precursor to which a fluid, typically water, is added to form a ready-to-drink beverage, or a “beverage.” Typically, the volumetric ratio of syrup to water is between 1:3 to 1:8, more typically between 1:4 and 1:6. The volumetric ratio of syrup to water also is expressed as a “throw.” A 1:5 ratio, which is a ratio commonly used within the beverage industry, is known as a “1+5 throw.”

“Steviol glycoside mixture comprising reb M”, as used herein, refers to a mixture containing at least about 80% reb M by weight, such as, for example, at least about 85% by weight, at least about 90% by weight, at least about 95% by weight, at least about 97% by weight or any range in between.

The steviol glycoside mixture comprising reb M can be RebM80. “RebM80” refers to a steviol glycoside mixture containing at least 80% Reb M by weight (the majority of the remainder is Reb D and Reb A). The total steviol glycoside content of the mixture is at least 95%. The steviol glycoside mixture comprising reb M can also be 95% reb M, i.e. a steviol glycoside mixture comprising reb M in about 95% by weight.

### II. Steviol Glycoside Blends of the Present Invention

Unless stated otherwise, the purity of the steviol glycoside is at least about 95% by weight.

In one embodiment, a quaternary steviol glycoside blend of the present invention comprises rebaudioside A, rebaudioside B, rebaudioside D and rebaudioside M. In a more particular embodiment, a quaternary steviol glycoside blend consists essentially of rebaudioside A, rebaudioside B, rebaudioside D and rebaudioside M. In a still more particular embodiment, a quaternary steviol glycoside blend consists of rebaudioside A, rebaudioside B, rebaudioside D and rebaudioside M.

The quaternary steviol glycoside blend comprises from about 26% to about 35% rebaudioside A by weight, such as, for example, from about 26% to about 30% or about 30% to about 35%. In particular embodiments, the quaternary steviol glycoside comprises 26% rebaudioside A by weight, 27% rebaudioside A by weight, 28% rebaudioside A by weight, 29% rebaudioside A by weight, 30% rebaudioside A by weight, 31% rebaudioside A by weight, 32% rebaudioside A by weight, 33% rebaudioside A by weight, 34% rebaudioside A by weight, 35% rebaudioside A by weight, or any range in between.

The quaternary steviol glycoside blend comprises from about 40% to about 49% rebaudioside M by weight, such as, for example, from about 45% to about 50% or about 40% to about 45%. In particular embodiments, the quaternary steviol glycoside blend comprises 40% rebaudioside M by weight, 41% rebaudioside M by weight, 42% rebaudioside M by weight, 43% rebaudioside M by weight, 44% rebaudioside M by weight, 45% rebaudioside M by weight, 46% rebaudioside M by weight, 47% rebaudioside M by weight, 48% rebaudioside M by weight, 49% rebaudioside M by weight, or any range in between.

As such, the quaternary steviol glycoside blend comprises at least about 66% rebaudioside A and rebaudioside M.

The quaternary steviol glycoside blend comprises from about 15% to about 25% rebaudioside B by weight, such as, for example, from about 20% to about 25% or about 15% to about 20%. In a particular embodiment, the quaternary steviol glycoside blend comprises from about 21 wt % to about 25% rebaudioside B by weight. In particular embodiments, the quaternary steviol glycoside blend comprises 15% rebaudioside B by weight, 16% rebaudioside B by weight, 17% rebaudioside B by weight, 18% rebaudioside B by weight, 19% rebaudioside B by weight, 20% rebaudioside B by weight, 21% rebaudioside B by weight, 22% rebaudioside B by weight, 23% rebaudioside B by weight, 24% rebaudioside B by weight, 25% rebaudioside B by weight, or any range in between.

The quaternary steviol glycoside blend comprises from about 5% to about 15% rebaudioside D by weight, such as, for example, from about 10% to about 15% or about 5% to about 10%. In a particular embodiment, the quaternary steviol glycoside blend comprises from about 5% to about 9% rebaudioside D by weight. In particular embodiments, the quaternary steviol glycoside blend comprises 5% rebaudioside D by weight, 6% rebaudioside D by weight, 7% rebaudioside D by weight, 8% rebaudioside D by weight, 9% rebaudioside D by weight, 10% rebaudioside D by weight, 11% rebaudioside D by weight, 12% rebaudioside D by weight, 13% rebaudioside D by weight, 14% rebaudioside D by weight, 15% rebaudioside D by weight, or any range in between.

Taken together, a quaternary steviol glycoside blend of the present invention comprises from about 26% to about 35% rebaudioside A by weight, from about 40% to about 49% rebaudioside M by weight, from about 15% to about 25% rebaudioside B by weight and from about 5% to about 15% rebaudioside D by weight.

In a more particular embodiment, a quaternary steviol glycoside blend of the present invention comprises from about 30% to about 35% rebaudioside A by weight, from about 40% to about 45% rebaudioside M by weight, from about 15% to about 20% rebaudioside B by weight and from about 5% to about 10% rebaudioside D by weight.

In another more particular embodiment, a quaternary steviol glycoside blend of the present invention comprises from about 26% to about 30% rebaudioside A by weight, from about 40% to about 45% rebaudioside M by weight, from about 15% to about 20% rebaudioside B by weight and from about 5% to about 10% rebaudioside D by weight.

In another embodiment, a ternary steviol glycoside blend of the present invention comprises rebaudioside B, rebaudioside D and rebaudioside M. In a more particular embodiment, a ternary steviol glycoside blend consists essentially of rebaudioside B, rebaudioside D and rebaudioside M. In a still more particular embodiment, a ternary steviol glycoside blend consists of rebaudioside B, rebaudioside D and rebaudioside M.

The ternary steviol glycoside blend comprises from about 26% to about 35% rebaudioside B by weight, such as, for example, from about 26% to about 30% or about 30% to about 35%. In particular embodiments, the ternary steviol glycoside blend comprises 26% rebaudioside B by weight, 27% rebaudioside B by weight, 28% rebaudioside B by weight, 29% rebaudioside B by weight, 30% rebaudioside B by weight, 31% rebaudioside B by weight, 32% rebaudioside B by weight, 33% rebaudioside B by weight, 34% rebaudioside B by weight, 35% rebaudioside B by weight, or any range in between.

The ternary steviol glycoside blend comprises from about 10% to about 15% rebaudioside D by weight. In a particular embodiment, the ternary steviol glycoside blend comprises 10% rebaudioside D by weight, 11% rebaudioside D by weight, 12% rebaudioside D by weight, 13% rebaudioside D by weight, 14% rebaudioside D by weight, 15% rebaudioside D by weight, or any range in between.

The ternary steviol glycoside blend comprises from about 55% to about 60% rebaudioside M by weight. In particular embodiments, the ternary steviol glycoside blend comprises 55% rebaudioside M by weight, 56% rebaudioside M by weight, 57% rebaudioside M by weight, 58% rebaudioside M by weight, 59% rebaudioside M by weight, 60% rebaudioside M by weight, or any range in between.

Taken together, a ternary steviol glycoside blend of the present invention comprises from about 26% to about 35% rebaudioside B by weight, from about 10% to about 15% rebaudioside D by weight and from about 55% to about 60% rebaudioside M by weight.

In a more particular embodiment, a ternary steviol glycoside blend of the present invention comprises from about 30% to about 35% rebaudioside B by weight, from about 10% to about 15% rebaudioside D by weight and from about 55% to about 60% rebaudioside M by weight.

In still another embodiment, a ternary steviol glycoside blend of the present invention comprises rebaudioside A, rebaudioside B and rebaudioside M. In a more particular embodiment, a ternary steviol glycoside blend consists essentially of rebaudioside A, rebaudioside B and rebaudioside M. In a still more particular embodiment, a ternary steviol glycoside blend consists of rebaudioside A, rebaudioside B and rebaudioside M.

The ternary steviol glycoside blend comprises from about 26% to about 35% rebaudioside A by weight, such as, for example, from about 26% to about 30% or about 30% to about 35%. In particular embodiments, the ternary steviol glycoside comprises 26% rebaudioside A by weight, 27% rebaudioside A by weight, 28% rebaudioside A by weight, 29% rebaudioside A by weight, 30% rebaudioside A by weight, 31% rebaudioside A by weight, 32% rebaudioside A by weight, 33% rebaudioside A by weight, 34% rebaudioside A by weight, 35% rebaudioside A by weight, or any range in between.

The ternary steviol glycoside blend comprises from about 15% to about 25% rebaudioside B by weight, such as, for example, from about 20% to about 25% or about 15% to about 20%. In a particular embodiment, the ternary steviol glycoside blend comprises from about 21 wt % to about 25% rebaudioside B by weight. In particular embodiments, the ternary steviol glycoside blend comprises 15% rebaudioside B by weight, 16% rebaudioside B by weight, 17% rebaudioside B by weight, 18% rebaudioside B by weight, 19% rebaudioside B by weight, 20% rebaudioside B by weight, 21% rebaudioside B by weight, 22% rebaudioside B by weight, 23% rebaudioside B by weight, 24% rebaudioside B by weight, 25% rebaudioside B by weight, or any range in between.

The ternary steviol glycoside blend comprises from about 40% to about 60% rebaudioside M by weight, such as, for example, from about 50% to about 60% or about 40% to about 50%. In particular embodiments, the quaternary steviol glycoside blend comprises 40% rebaudioside M by weight, 41% rebaudioside M by weight, 42% rebaudioside M by weight, 43% rebaudioside M by weight, 44% rebaudioside M by weight, 45% rebaudioside M by weight, 46% rebaudioside M by weight, 47% rebaudioside M by weight, 48% rebaudioside M by weight, 49% rebaudioside M by weight, 50% rebaudioside M by weight, 51% rebaudioside M by weight, 52% rebaudioside M by weight, 53% rebaudioside M by weight, 54% rebaudioside M by weight, 55% rebaudioside M by weight, 56% rebaudioside M by weight, 57% rebaudioside M by weight, 58% rebaudioside M by weight, 59% rebaudioside M by weight, 60% rebaudioside M by weight, or any range in between.

Taken together, a ternary steviol glycoside blend of the present invention comprises from about 26% to about 35% rebaudioside A by weight, from about 15% to about 25% rebaudioside B by weight and from about 40% to about 60% rebaudioside M by weight.

In a more particular embodiment, a ternary steviol glycoside blend of the present invention comprises from about 30% to about 35% rebaudioside A by weight, from about 20% to about 25% rebaudioside B by weight and from about 50% to about 60% rebaudioside M by weight.

In another more particular embodiment, a ternary steviol glycoside blend of the present invention comprises from about 26% to about 30% rebaudioside B by weight, from about 15% to about 20% rebaudioside D by weight and from about 40% to about 50% rebaudioside M by weight.

The ternary and quaternary steviol glycoside blends described hereinabove are all a “steviol glycoside blend of the present invention.”

The steviol glycoside blend of the present invention contains the above-mentioned rebaudiosides (A, B, D and M) in amounts effective to provide a total steviol glycoside concentration from about 50 ppm to about 600 ppm when added to a beverage, such as, for example, from about 100 ppm to about 600 ppm, from about 100 ppm to about 500 ppm, from about 100 ppm to about 400 ppm, from about 100 ppm to about 300 ppm, from about 100 ppm to about 200 ppm, from about 200 ppm to about 600 ppm, from about 200 ppm to about 500 ppm, from about 200 ppm to about 400 ppm, from about 200 ppm to about 300 ppm, from about 300 ppm to about 600 ppm, from about 300 ppm to about 500 ppm, from about 300 ppm to about 400 ppm, from about 400 ppm to about 600 ppm, from about 400 ppm to about 500 ppm and from about 500 ppm to about 600 ppm.

The quaternary steviol glycoside blend of the present invention comprises rebaudioside A in an amount effective to provide a rebaudioside A concentration from about 120 ppm to about 170 ppm when the blend is formulated into a beverage, rebaudioside M in an amount effective to provide a rebaudioside M concentration from about 190 ppm to about 240 ppm when the blend is formulated into a beverage, rebaudioside B in an amount effective to provide a rebaudioside B concentration from about 70 ppm to about 120 ppm when the blend is formulated into a beverage and rebaudioside D in an amount effective to provide a rebaudioside D concentration from about 20 ppm to about 75 ppm rebaudioside D when the blend is formulated into a beverage.

In a more particular embodiment, the quaternary steviol glycoside blend of the present invention comprises rebaudioside A in an amount effective to provide a rebaudioside A concentration from about 130 ppm to about 170 ppm when the blend is formulated into a beverage, rebaudioside M in an amount effective to provide a rebaudioside M concentration from about 205 ppm to about 220 ppm when the blend is formulated into a beverage, rebaudioside B in an amount effective to provide a rebaudioside B concentration from about 80 ppm to about 95 ppm when the blend is formulated into a beverage and rebaudioside D in an amount effective to provide a rebaudioside D concentration from about 25 ppm to about 50 ppm when the blend is formulated into a beverage.

The steviol glycoside blends of the present invention exhibit superior aqueous solubility compared to the steviol glycoside mixture comprising reb M, e.g. 95% reb M. The aqueous solubility of the steviol glycoside blend of the present invention at 0.25 wt %-0.4 wt % is at least about 1.5× more than the aqueous solubility of the blend of only the steviol glycoside mixture comprising reb M, such as, for example, at least about 1.7× more or least about 2.0× more.

In one embodiment, the steviol glycoside blend of the present invention is soluble at room temperature at relevant beverage syrup concentrations (e.g. about 0.25 wt % to about 0.35% or about 0.4 wt %) used to prepare beverages, e.g. carbonated soft drinks. In contrast, the steviol glycoside mixture comprising reb M is not soluble under such conditions and therefore cannot be formulated into a beverage syrup.

In another embodiment, the steviol glycoside blend of the present invention is soluble in a carbonated soft drink prepared from a beverage syrup comprising a steviol glycoside blend of the present invention and carbonated water with a 1:5.5 throw ratio at room temperature. In comparison, the steviol glycoside mixture comprising reb M is not soluble at the relevant concentration required to make a beverage syrup, and therefore cannot be formulated into a carbonated soft drink at room temperature (see Example 1).

In still another embodiment, the steviol glycoside blends of the present invention can be used to prepare a carbonated soft drink having at least about 300 ppm steviol glycoside concentration, e.g. from about 400 ppm to about 600 ppm or from about 400 ppm to about 500 ppm, wherein the carbonated soft drink is prepared at room temperature from a beverage syrup comprising said steviol glycoside blend. In contrast, the steviol glycoside mixture comprising reb M is not soluble at the relevant concentration required to make a beverage syrup, and therefore cannot be prepared into a carbonated soft drink at room temperature (see Example 1).

A number of methods are known in the art for determining aqueous solubility. In one such method, solubility can be determined by a solvent addition method in which a weighed sample is treated with aliquots of water. The mixture is generally vortexed and/or sonicated between additions to facilitate dissolution. Complete dissolution of the test material is determined by visual inspection. Solubility is calculated based on the total solvent used to provide complete dissolution. In particular, the amount of sample added divided by the weight of the solute (water+sample)×100 provides the solubility in (% w/w). For example, if 0.18 g of sample can be dissolved in 30 g of water, the water solubility is 0.6%.

The steviol glycoside blends of the present invention provide a sucrose equivalence of greater than about 8% (w/v) when added to a beverage, such as, for example, greater than about 9%, about 10%, about 11%, about 12%, about 13% or about 14%. In exemplary embodiments, the steviol glycoside blend of the present invention provides a sucrose equivalence of about 10% or greater when added to a beverage.

The steviol glycoside blends of the present invention can be prepared by spray-drying. In one embodiment, a method for preparing a spray-dried steviol glycoside blend of the present invention comprises:

(i) heating a mixture comprising water and a steviol glycoside blend of the present invention to a temperature between about 70° C. and about 100° C.,

(ii) maintaining the mixture at the temperature in (i) to provide a concentrated solution,

(iii) decreasing the temperature to not below about 70° C., and

(iv) spray-drying the concentrated solution while maintaining the feed temperature above about 70° C.

In some embodiments the blend of the present invention is heated in (i) to from about 70° C. to about 100° C., such as, for example, from about 80° C. to about 100° C., from about 90° C. to about 100° C., from about 70° C. to about 90° C., from about 70° C. to about 80° C. and from about 80° C. to about 90° C.

The resulting spray-dried steviol glycoside blend of the present invention has an aqueous solubility of at least about 3 wt %, such as, for example, at least about 4 wt %, at least about 5 wt %, or from about 3 wt % to about 5 wt %.

A blend of the present invention comprises a steviol glycoside blend of the present invention, and further comprises a composition comprising glucosylated steviol glycosides (GSG). Compositions comprising GSG are typically used as flavor and taste enhancers and are commercially available from, e.g. Pure Circle. GSG are prepared by intermolecular transglycosylation of steviol glycosides using glucose donor molecules and various enzymes that add new carbohydrates (particularly glucose) at the C13 and C19 positions of the starting steviol glycoside.

Various enzymes can be used to conduct such transglycosylation. Pullulanase, isomaltase (Lobov, S. V. et al., “Enzymic Production of Sweet Stevioside Derivatives: Transglucosylation by Glucosidases,” Agric. Biol. Chem., Vol. 55, No. 12, pp. 2959-2965 (1991)), 3-galactosidase (Kitahata, S. et al., “Production of Rubusoside Derivatives by Transgalactosylation of Various (3-Galactosidases,” Agric. Biol. Chem., Vol. 53, No. 1 1, pp. 2923-2928 (1989)), and dextrine saccharase (Yamamoto, K. et al., Biosci. Biotech. Biochem., Vol. 58, No. 9, pp. 1657-1661 (1994)) were used as enzymes with pullulan, maltose, lactose, and partially hydrolyzed starch being donors. The transglucosylation of steviol glycosides was also achieved by the action of cyclodextrin glucanotransferases (CGTase). The obtained sweeteners possessed improved sweetness without bitterness and licorice taste (U.S. Pat. Nos. 4,219,571, 7,838,044, and 7,807,206).

The composition comprising GSG contains glucosylated steviol glycosides having, for example, three, four, five, or more than five glucose units.

In one embodiment, the composition comprising GSG comprises at least about 80% GSG by weight, such as, for example, at least about 85% GSG by weight, at least about 90% GSG by weight, at least about 95% GSG by weight or at least about 97% GSG by weight. The remainder of the composition comprising GSG can further contain starting steviol glycosides (e.g. stevioside, rebaudioside A, etc) and glucose donors.

In one embodiment, the composition comprising GSG is selected from the group consisting of NSF-02, NSF-03, NSF-04 and combinations thereof. In a particular embodiment, the composition comprising GSG is NSF-03.

The composition comprising GSG is present in a blend of the present invention in an amount effective to provide a concentration from about 5 ppm to about 50 ppm when the blend is formulated into a finished beverage, such as, for example, from about 10 ppm to about 50 ppm, from about 20 ppm to about 50 ppm, from about 20 ppm to about 40 ppm, from about 20 ppm to about 30 ppm, from about 30 ppm to about 50 ppm, from about 30 ppm to about 40 ppm and from about 40 ppm to about 50 ppm. In a particular embodiment, the composition comprising GSG is present in a blend in an amount effect to provide a concentration from about 15 ppm to about 30 ppm or from about 20 ppm to about 30 ppm.

Blends of the present invention comprising a composition comprising GSG provide superior sensory properties when formulated into a beverage compared to blends without the composition comprising GSG. Sensory properties include, but are not limited to, sweetness, astringency, acid notes, off notes, sweetness lingering, bitterness, bitterness lingering, mouthfeel, sourness, saltiness, metallic notes, and sweetness onset. Methods of determining these properties are known in the art and demonstrated in the Examples. In certain embodiments, multiple taste attributes are positively modulated simultaneously.

### III. Concentrates and Beverage Syrups

The present invention also provides concentrates comprising the blends of the present invention described above, i.e. steviol glycoside blends of the present invention and blends comprising the steviol glycoside blend of the present invention and a composition comprising GSG.

The concentrates have concentrations of about 0.25 wt % or more, such as, for example, at least about 0.3 wt %, 0.4 wt %, at least about 0.5 wt % or at least about 1.0 wt %. In one embodiment, the concentrates have blend concentrations from about 0.25 wt % to about 0.4 wt %. The concentrates are solutions, i.e. they are not cloudy and there are no particulates present.

Concentrates of the present invention are prepared by (i) diluting a super concentrate to the desired concentration/wt % with water at room temperature and (ii) mixing. The mixing time can vary. As such, the mixture can be stirred for at least 10 minutes, at least 1 hour, at least 24 hours or at least 90 hours.

Concentrates containing blends of the present invention at 0.25 wt %-0.4 wt % exhibit superior aqueous solubility compared to the steviol glycoside mixture comprising reb M. As noted above, the steviol glycoside mixture comprising rebaudioside M (e.g. 95% reb M) cannot be formulated into a concentrate at 0.25 wt %-0.4 wt % at room temperature.

Super concentrates have concentrations of about 1 wt % to about 10 wt %, such as, for example, about 2 wt %, about 3 wt %, about 4 wt %, about 5 wt %, about 6 wt %, about 7 wt %, about 8 wt %, about 9 wt and any range between. In a particular embodiment, the super concentrate has a concentration from about 3 wt % to about 5 wt %.

The concentrates are prepared from the super concentrate. The super concentrate is prepared by (i) combining the relevant blend of the present invention and water at room temperature to provide a mixture (both the blend of the present invention and water are present in amounts necessary to provide the desired concentration/wt %) and (ii) stirring the mixture at room temperature. The resulting super concentrate is a cloudy mixture, i.e. not a solution.

The present invention also provides beverage syrups prepared using the concentrates described herein and methods for making beverage syrups.

In one embodiment, a method of making a beverage syrup comprises combining beverage syrup ingredients with the concentrate. In one embodiment, the beverage syrup ingredients are added to a concentrate to provide a beverage syrup.

In a particular embodiment, the concentrate comprises the steviol glycoside blend of the present invention and the composition comprising GSG is added to the beverage syrup (i.e. it acts as a beverage syrup ingredient)

In other embodiments, the concentrate can be diluted prior to combination with beverage syrup ingredients. The dilution can be done at once or in a serial fashion. The temperature for dilution is preferably the same temperature at which the beverage syrup ingredients are formulated, typically room temperature- but not above about 70° C. for thermally sensitive ingredients.

The skilled practitioner recognizes that beverage syrup ingredients can be added singularly or in combination. Also, solutions of dry beverage syrup ingredients can be made and used to add to the bulk quantity of water. Beverage syrup ingredients typically are added to the bulk quantity of water in an order that minimizes potential adverse interactions between ingredients or potential adverse effect on an ingredient. For example, nutrients that are temperature-sensitive might be added during a relatively low-temperature portion toward the end of the manufacturing process. Similarly, flavors and flavor compounds often are added just before completion of the syrup to minimize potential loss of volatile components and to minimize flavor loss in any form. Often, acidification is one of the last steps, typically carried out before temperature-sensitive, volatile, and flavor materials are added. Thus, flavors or flavor components or other volatile materials and nutrients typically are added at an appropriate time and at an appropriate temperature.

Beverage syrup ingredients include, but are not limited to, additional sweeteners, functional ingredients and additives, described herein below.

The pH of the beverage syrup is typically from about 2.0 to about 5, such as, for example, from about 2.5 to about 4. The pH may be adjusted by addition of a suitable acid or base such as, but not limited to phosphoric acid, citric acid, or sodium hydroxide.

The resulting beverage syrup is packaged and may be stored. A beverage syrup may be used essentially immediately to manufacture beverages, which typically are packaged for distribution. A beverage syrup also may be distributed to bottlers, who package beverages made by addition of water and perhaps other materials like carbonation.

The beverage syrup can be a full-calorie beverage syrup such that a ready-to-drink beverage prepared from the beverage syrup has up to about 120 calories per 8 oz serving.

The beverage syrup can be a mid-calorie beverage syrup, such that a ready-to-drink beverage prepared from the beverage syrup has up to about 60 calories per 8 oz. serving.

The beverage syrup can be a low-calorie beverage syrup, such that a ready-to-drink beverage prepared from the beverage syrup has up to about 40 calories per 8 oz. serving.

The beverage syrup can be a zero-calorie beverage syrup, such that a ready-to-drink beverage prepared from the beverage syrup has less than about 5 calories per 8 oz. serving.

### IV. Beverages

The present invention also provides ready-to-drink beverages prepared from the beverage syrups described herein and methods of preparing ready-to-drink beverages.

The present invention also provides beverages comprising steviol glycoside blends of the present invention (described herein above) and beverages comprising blends of the present invention (also described herein above).

Ready-to-drink beverages include carbonated and non-carbonated beverages. Carbonated beverages include, but are not limited to, frozen carbonated beverages, enhanced sparkling beverages, cola, fruit-flavored sparkling beverages (e.g. lemon-lime, orange, grape, strawberry and pineapple), ginger-ale, soft drinks and root beer. Non-carbonated beverages include, but are not limited to, fruit juice, fruit-flavored juice, juice drinks, nectars, vegetable juice, vegetable-flavored juice, sports drinks, energy drinks, enhanced water drinks, enhanced water with vitamins, near water drinks (e.g., water with natural or synthetic flavorants), coconut water, tea type drinks (e.g. black tea, green tea, red tea, oolong tea), coffee, cocoa drink, beverage containing milk components (e.g. milk beverages, coffee containing milk components, café au lait, milk tea, fruit milk beverages), beverages containing cereal extracts and smoothies.

In a particular embodiment, the beverage is a carbonated soft drink (CSD).

Beverages comprise a matrix, i.e. the basic ingredient in which the ingredients—including the compositions of the present invention—are dissolved. In one embodiment, a beverage comprises water of beverage quality as the matrix, such as, for example deionized water, distilled water, reverse osmosis water, carbonated water, purified water, demineralized water and combinations thereof, can be used. Additional suitable matrices include, but are not limited to phosphoric acid, phosphate buffer, citric acid, citrate buffer and carbon-treated water.

A method of preparing a beverage comprises mixing a beverage syrup described herein with an appropriate quantity of diluting water or other suitable matrix. In one embodiment, the beverage is a carbonated beverage (e.g. fountain drink or soft drink) and the diluting water is carbonated water.

Typically, the volumetric ratio of syrup to water is between 1:3 to 1:8, such as, for example, between 1:3 and 1:8, between 1:3 and 1:7, between 1:3 and 1:6, between 1:3 and 1:5, between 1:3 and 1:4, between 1:4 and 1:8, between 1:4 and 1:7, between 1:4 and 1:6, between 1:4 and 1:5, between 1:5 and 1:8, between 1:5 and 1:7, between 1:5 and 1:6, between 1:6 and 1:8, between 1:6 and 1:7 and between 1:7 and 1:8. In a particular embodiment, the volumetric ration of syrup to water is about 1:5.5.

The temperature at which the mixing is done is preferably room temperature.

The concentrates and beverage syrups of the instant invention can be formulated into beverages by typical equipment found in a bottling facility. No special equipment or heating steps are required.

The beverages can further include at least one additional sweetener, additive and/or functional ingredient. Any of the sweeteners detailed herein can be used. These may be added to the beverage during or after dilution of the beverage syrup.

Beverages of the present invention have a steviol glycoside concentration (from the steviol glycoside blend of the present invention) from about 100 ppm to about 1,000 ppm, such as, for example, from about 100 ppm to about 600 ppm, from about 100 ppm to about 500 ppm, from about 100 ppm to about 400 ppm, from about 100 ppm to about 300 ppm, from about 100 ppm to about 200 ppm, from about 200 ppm to about 600 ppm, from about 200 ppm to about 500 ppm, from about 200 ppm to about 400 ppm, from about 200 ppm to about 300 ppm, from about 300 ppm to about 600 ppm, from about 300 ppm to about 500 ppm, from about 300 ppm to about 400 ppm, from about 400 ppm to about 600 ppm, from about 400 ppm to about 500 ppm and from about 500 ppm to about 600 ppm.

Beverages of the present invention prepared using the quaternary steviol glycoside blends of the present invention comprise rebaudioside A in a concentration from about 120 ppm to about 170 ppm, rebaudioside M in a concentration from about 190 ppm to about 240 ppm, rebaudioside B in a concentration from about 70 ppm to about 120 ppm and rebaudioside D in a concentration from about 20 ppm to about 75 ppm. In a more particular embodiment, beverages of the present invention prepared using the quaternary steviol glycoside blends of the present invention comprise rebaudioside A in a concentration from about 130 ppm to about 170 ppm, rebaudioside M in a concentration from about 205 ppm to about 220 ppm, rebaudioside B in a concentration from about 80 ppm to about 95 ppm and rebaudioside D in a concentration from about 25 ppm to about 50 ppm.

Beverages of the present invention prepared using the ternary steviol glycoside blend of the present invention comprising rebaudiosides B, D and M comprise . . .

Beverages of the present invention prepared using the ternary steviol glycoside blend of the present invention comprising rebaudiosides A, D and M comprise . . .

Beverages of the present invention contain the composition comprising GSG in a concentration from about 5 ppm to about 50 ppm, such as, for example, from about 10 ppm to about 50 ppm, from about 20 ppm to about 50 ppm, from about 20 ppm to about 40 ppm, from about 20 ppm to about 30 ppm, from about 30 ppm to about 50 ppm, from about 30 ppm to about 40 ppm and from about 40 ppm to about 50 ppm. In a particular embodiment, the composition comprising GSG is present in a concentration from about 15 ppm to about 30 ppm or from about 20 ppm to about 30 ppm.

The beverages of the present invention have a sucrose equivalence of greater than about 8% (w/v), such as, for example, greater than about 9%, about 10%, about 11%, about 12%, about 13% or about 14%. In exemplary embodiments, the beverage has a sucrose equivalence of about 10% or greater when added to a consumable.

In a particular embodiment, the steviol glycoside blend and the composition comprising GSG provide all of the sucrose equivalence of the beverage. In one embodiment, the steviol glycoside blend of the present invention provides all of the sucrose equivalence of the beverage.

The beverage can be a full-calorie beverage that has up to about 120 calories per 8 oz serving. The beverage can be a mid-calorie beverage that has up to about 60 calories per 8 oz. serving. The beverage can be a low-calorie beverage that has up to about 40 calories per 8 oz. serving. The beverage can be a zero-calorie that has less than about 5 calories per 8 oz. serving

Beverages of the present invention comprising (i) a steviol glycoside blend of the present invention and (ii) a composition comprising GSG have superior sensory properties compared to beverages comprising only (i) (i.e., without the composition comprising GSG). Sensory properties include, but are not limited to, sweetness, astringency, acid notes, off notes, sweetness lingering, bitterness, bitterness lingering and sweetness onset.

In exemplary embodiments, a zero-calorie beverage having at least about 8% sucrose equivalence comprises (i) a steviol glycoside blend of the present invention and (ii) a composition comprising GSG, wherein the beverage has a steviol glycoside concentration (from the steviol glycoside blend of the present invention) from about 100 ppm to about 600 ppm and a composition comprising GSG concentration from about 5 ppm to about 50 ppm.

In other embodiments, a zero-calorie beverage having at least about 10% sucrose equivalence comprises (i) a steviol glycoside blend of the present invention and (ii) a composition comprising GSG, wherein the beverage has a steviol glycoside concentration (from the steviol glycoside blend of the present invention) from about 400 ppm to about 600 ppm and a composition comprising GSG concentration from about 5 ppm to about 50 ppm.

In exemplary embodiments, a zero-calorie beverage having at least about 8% sucrose equivalence comprises (i) a steviol glycoside blend of the present invention and (ii) a composition comprising GSG, wherein the beverage has a rebaudioside A concentration from about 120 ppm to about 170 ppm, a rebaudioside M concentration from about 190 ppm to about 240 ppm, a rebaudioside B concentration from about 70 ppm to about 120 ppm, a rebaudioside D concentration from about 20 ppm to about 75 ppm and a composition comprising GSG concentration from about 5 ppm to about 50 ppm.

In a more particular embodiment, a zero-calorie beverage having at least about 8% sucrose equivalence comprises (i) a steviol glycoside blend of the present invention and (ii) a composition comprising GSG, wherein the beverage has a rebaudioside A concentration from about 130 ppm to about 170 ppm, a rebaudioside M concentration from about 205 ppm to about 220 ppm, a rebaudioside B concentration from about 80 ppm to about 95 ppm, a rebaudioside D concentration from about 25 ppm to about 50 ppm and a composition comprising GSG concentration from about 20 ppm to about 30 ppm.

The pH of the beverage does not materially or adversely affect the taste of the sweetener. A non-limiting example of the pH range of the beverage may be from about 1.8 to about 10. A further example includes a pH range from about 2 to about 5. In a particular embodiment, the pH of beverage can be from about 2.5 to about 4.2. On of skill in the art will understand that the pH of the beverage can vary based on the type of beverage. Dairy beverages, for example, can have pHs greater than 4.2.

The titratable acidity of a beverage may, for example, range from about 0.01 to about 1.0% by weight of beverage.

In one embodiment, the sparkling beverage product has an acidity from about 0.01 to about 1.0% by weight of the beverage, such as, for example, from about 0.05% to about 0.25% by weight of beverage.

The carbonation of a sparkling beverage product has 0 to about 2% (w/w) of carbon dioxide or its equivalent, for example, from about 0.1 to about 1.0% (w/w).

The beverage can be caffeinated or non-caffeinated.

The temperature of a beverage may, for example, range from about 4° C. to about 100° C., such as, for example, from about 4° C. to about 25° C.

### V. Additives

The concentrates, beverage syrups and/or beverages of the present invention can further comprise one or more sweeteners, additives and/or functional ingredients.

The additional sweetener can be any known sweetener, e.g. a natural sweetener, a natural high potency sweetener, a synthetic sweetener.

Suitable sweeteners include carbohydrate sweeteners selected from the group consisting of sucrose, glyceraldehyde, dihydroxyacetone, erythrose, threose, erythrulose, arabinose, lyxose, ribose, xylose, ribulose, xylulose, allose, altrose, galactose, glucose, gulose, idose, mannose, talose, fructose, psicose, sorbose, tagatose, mannoheptulose, sedoheltulose, octolose, fucose, rhamnose, arabinose, turanose, sialose and combinations thereof.

Other suitable sweeteners include rebaudioside A, rebaudioside B, rebaudioside C, rebaudioside D, rebaudioside E, rebaudioside F, rebaudioside I, rebaudioside H, rebaudioside L, rebaudioside K, rebaudioside J, rebaudioside N, rebaudioside O, dulcoside A, dulcoside B, rubusoside, stevia, stevioside, mogroside IV, mogroside V, Luo han guo, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobatin, baiyunoside, osladin, polypodoside A, pterocaryoside A, pterocaryoside B, mukurozioside, phlomisoside I, periandrin I, abrusoside A, steviolbioside and cyclocarioside I, sugar alcohols such as erythritol, sucralose, potassium acesulfame, acesulfame acid and salts thereof, aspartame, alitame, saccharin and salts thereof, neohesperidin dihydrochalcone, cyclamate, cyclamic acid and salts thereof, neotame, advantame, glucosylated steviol glycosides (GSGs) and combinations thereof.

Other suitable sweeteners include rare sugars selected from the group consisting of allulose, sorbose, lyxose, ribulose, xylose, xylulose, D-allose, L-ribose, D-tagatose, L-glucose, L-fucose, L-arabinose, turanose and combinations thereof.

Exemplary additives include, carbohydrates, polyols, amino acids and their corresponding salts, poly-amino acids and their corresponding salts, sugar acids and their corresponding salts, nucleotides, organic acids, inorganic acids, organic salts including organic acid salts and organic base salts, inorganic salts, bitter compounds, flavorants and flavoring ingredients, astringent compounds, proteins or protein hydrolysates, surfactants, emulsifiers, weighing agents, gums, antioxidants, colorants, flavonoids, alcohols, polymers and combinations thereof. In some embodiments, the additives act to improve the temporal and flavor profile of the ternary blend to provide a sweetener composition with a taste similar to sucrose.

“Polyol”, as used herein, refers to a molecule that contains more than one hydroxyl group. A polyol may be a diol, triol, or a tetraol which contains 2, 3, and 4 hydroxyl groups respectively. A polyol also may contain more than 4 hydroxyl groups, such as a pentaol, hexaol, heptaol, or the like, which contain 5, 6, or 7 hydroxyl groups, respectively. Additionally, a polyol also may be a sugar alcohol, polyhydric alcohol, or polyalcohol which is a reduced form of carbohydrate, wherein the carbonyl group (aldehyde or ketone, reducing sugar) has been reduced to a primary or secondary hydroxyl group.

Non-limiting examples of polyols in some embodiments include erythritol, maltitol, mannitol, sorbitol, lactitol, xylitol, isomalt, propylene glycol, glycerol (glycerin), threitol, galactitol, palatinose, reduced isomalto-oligosaccharides, reduced xylo-oligosaccharides, reduced gentio-oligosaccharides, reduced maltose syrup, reduced glucose syrup, and sugar alcohols or any other carbohydrates capable of being reduced which do not adversely affect the taste of the compositions.

Suitable amino acid additives include, but are not limited to, aspartic acid, arginine, glycine, glutamic acid, proline, threonine, theanine, cysteine, cystine, alanine, valine, tyrosine, leucine, arabinose, trans-4-hydroxyproline, isoleucine, asparagine, serine, lysine, histidine, ornithine, methionine, carnitine, aminobutyric acid (α-, β-, and/or δ-isomers), glutamine, hydroxyproline, taurine, norvaline, sarcosine, and their salt forms such as sodium or potassium salts or acid salts. The amino acid additives also may be in the D- or L-configuration and in the mono-, di-, or tri-form of the same or different amino acids. Additionally, the amino acids may be α-, β-, γ- and/or δ-isomers if appropriate. Combinations of the foregoing amino acids and their corresponding salts (e.g., sodium, potassium, calcium, magnesium salts or other alkali or alkaline earth metal salts thereof, or acid salts) also are suitable additives in some embodiments. The amino acids may be natural or synthetic. The amino acids also may be modified. Modified amino acids refers to any amino acid wherein at least one atom has been added, removed, substituted, or combinations thereof (e.g., N-alkyl amino acid, N-acyl amino acid, or N-methyl amino acid). Non-limiting examples of modified amino acids include amino acid derivatives such as trimethyl glycine, N-methyl-glycine, and N-methyl-alanine. As used herein, modified amino acids encompass both modified and unmodified amino acids. As used herein, amino acids also encompass both peptides and polypeptides (e.g., dipeptides, tripeptides, tetrapeptides, and pentapeptides) such as glutathione and L-alanyl-L-glutamine. Suitable polyamino acid additives include poly-L-aspartic acid, poly-L-lysine (e.g., poly-L-α-lysine or poly-L-ε-lysine), poly-L-ornithine (e.g., poly-L-α-ornithine or poly-L-ε-ornithine), poly-L-arginine, other polymeric forms of amino acids, and salt forms thereof (e.g., calcium, potassium, sodium, or magnesium salts such as L-glutamic acid mono sodium salt). The poly-amino acid additives also may be in the D- or L-configuration. Additionally, the poly-amino acids may be α-, β-, γ-, δ-, and ε-isomers if appropriate. Combinations of the foregoing poly-amino acids and their corresponding salts (e.g., sodium, potassium, calcium, magnesium salts or other alkali or alkaline earth metal salts thereof or acid salts) also are suitable additives in some embodiments. The poly-amino acids described herein also may comprise co-polymers of different amino acids. The poly-amino acids may be natural or synthetic. The poly-amino acids also may be modified, such that at least one atom has been added, removed, substituted, or combinations thereof (e.g., N-alkyl poly-amino acid or N-acyl poly-amino acid). As used herein, poly-amino acids encompass both modified and unmodified poly-amino acids. For example, modified poly-amino acids include, but are not limited to, poly-amino acids of various molecular weights (MW), such as poly-L-α-lysine with a MW of 1,500, MW of 6,000, MW of 25,200, MW of 63,000, MW of 83,000, or MW of 300,000.

Suitable sugar acid additives include, but are not limited to, aldonic, uronic, aldaric, alginic, gluconic, glucuronic, glucaric, galactaric, galacturonic, and salts thereof (e.g., sodium, potassium, calcium, magnesium salts or other physiologically acceptable salts), and combinations thereof.

Suitable nucleotide additives include, but are not limited to, inosine monophosphate (“IMP”), guanosine monophosphate (“GMP”), adenosine monophosphate (“AMP”), cytosine monophosphate (CMP), uracil monophosphate (UMP), inosine diphosphate, guanosine diphosphate, adenosine diphosphate, cytosine diphosphate, uracil diphosphate, inosine triphosphate, guanosine triphosphate, adenosine triphosphate, cytosine triphosphate, uracil triphosphate, alkali or alkaline earth metal salts thereof, and combinations thereof. The nucleotides described herein also may comprise nucleotide-related additives, such as nucleosides or nucleic acid bases (e.g., guanine, cytosine, adenine, thymine, uracil).

The nucleotide is present in the sweetener composition in an amount effective to provide a concentration from about 5 ppm to about 1,000 ppm when present in consumable, such as, for example, a beverage.

Suitable organic acid additives include any compound which comprises a —COOH moiety, such as, for example, C2-C30 carboxylic acids, substituted hydroxyl C2-C30 carboxylic acids, butyric acid (ethyl esters), substituted butyric acid (ethyl esters), benzoic acid, substituted benzoic acids (e.g., 2,4-dihydroxybenzoic acid), substituted cinnamic acids, hydroxyacids, substituted hydroxybenzoic acids, anisic acid substituted cyclohexyl carboxylic acids, tannic acid, aconitic acid, lactic acid, tartaric acid, citric acid, isocitric acid, gluconic acid, glucoheptonic acids, adipic acid, hydroxycitric acid, malic acid, fruitaric acid (a blend of malic, fumaric, and tartaric acids), fumaric acid, maleic acid, succinic acid, chlorogenic acid, salicylic acid, creatine, caffeic acid, bile acids, acetic acid, ascorbic acid, alginic acid, erythorbic acid, polyglutamic acid, glucono delta lactone, and their alkali or alkaline earth metal salt derivatives thereof. In addition, the organic acid additives also may be in either the D- or L-configuration.

Suitable organic acid additive salts include, but are not limited to, sodium, calcium, potassium, and magnesium salts of all organic acids, such as salts of citric acid, malic acid, tartaric acid, fumaric acid, lactic acid (e.g., sodium lactate), alginic acid (e.g., sodium alginate), ascorbic acid (e.g., sodium ascorbate), benzoic acid (e.g., sodium benzoate or potassium benzoate), sorbic acid and adipic acid. The examples of the organic acid additives described optionally may be substituted with at least one group chosen from hydrogen, alkyl, alkenyl, alkynyl, halo, haloalkyl, carboxyl, acyl, acyloxy, amino, amido, carboxyl derivatives, alkylamino, dialkylamino, arylamino, alkoxy, aryloxy, nitro, cyano, sulfo, thiol, imine, sulfonyl, sulfenyl, sulfinyl, sulfamyl, carboxalkoxy, carboxamido, phosphonyl, phosphinyl, phosphoryl, phosphino, thioester, thioether, anhydride, oximino, hydrazino, carbamyl, phosphor or phosphonato.

Suitable inorganic acid additives include, but are not limited to, phosphoric acid, phosphorous acid, polyphosphoric acid, hydrochloric acid, sulfuric acid, carbonic acid, sodium dihydrogen phosphate, and alkali or alkaline earth metal salts thereof (e.g., inositol hexaphosphate Mg/Ca).

The inorganic acid additive is present in the sweetener composition in an amount effective to provide a concentration from about 25 ppm to about 25,000 ppm when present in a consumable, such as, for example, a beverage.

Suitable bitter compound additives include, but are not limited to, caffeine, quinine, urea, bitter orange oil, naringin, quassia, and salts thereof.

Suitable flavorants and flavoring ingredient additives include, but are not limited to, vanillin, vanilla extract, mango extract, cinnamon, citrus, coconut, ginger, viridiflorol, almond, menthol (including menthol without mint), grape skin extract, and grape seed extract. “Flavorant” and “flavoring ingredient” are synonymous and can include natural or synthetic substances or combinations thereof. Flavorants also include any other substance which imparts flavor and may include natural or non-natural (synthetic) substances which are safe for human or animals when used in a generally accepted range. Non-limiting examples of proprietary flavorants include Döhler™ Natural Flavoring Sweetness Enhancer K14323 (Döhler™, Darmstadt, Germany), Symrise™ Natural Flavor Mask for Sweeteners 161453 and 164126 (Symrise™, Holzminden, Germany), Natural Advantage™ Bitterness Blockers 1, 2, 9 and 10 (Natural Advantage™, Freehold, N.J., U.S.A.), and Sucramask™ (Creative Research Management, Stockton, Calif., U.S.A.).

Suitable polymer additives include, but are not limited to, chitosan, pectin, pectic, pectinic, polyuronic, polygalacturonic acid, starch, food hydrocolloid or crude extracts thereof (e.g., gum acacia senegal (Fibergum™), gum acacia seyal, carageenan), poly-L-lysine (e.g., poly-L-α-lysine or poly-L-ε-lysine), poly-L-ornithine (e.g., poly-L-α-ornithine or poly-L-ε-ornithine), polypropylene glycol, polyethylene glycol, poly(ethylene glycol methyl ether), polyarginine, polyaspartic acid, polyglutamic acid, polyethylene imine, alginic acid, sodium alginate, propylene glycol alginate, and sodium polyethyleneglycolalginate, sodium hexametaphosphate and its salts, and other cationic polymers and anionic polymers.

Suitable protein or protein hydrolysate additives include, but are not limited to, bovine serum albumin (BSA), whey protein (including fractions or concentrates thereof such as 90% instant whey protein isolate, 34% whey protein, 50% hydrolyzed whey protein, and 80% whey protein concentrate), soluble rice protein, soy protein, protein isolates, protein hydrolysates, reaction products of protein hydrolysates, glycoproteins, and/or proteoglycans containing amino acids (e.g., glycine, alanine, serine, threonine, asparagine, glutamine, arginine, valine, isoleucine, leucine, norvaline, methionine, proline, tyrosine, hydroxyproline, and the like), collagen (e.g., gelatin), partially hydrolyzed collagen (e.g., hydrolyzed fish collagen), and collagen hydrolysates (e.g., porcine collagen hydrolysate).

Suitable surfactant additives include, but are not limited to, polysorbates (e.g., polyoxyethylene sorbitan monooleate (polysorbate 80), polysorbate 20, polysorbate 60), sodium dodecylbenzenesulfonate, dioctyl sulfosuccinate or dioctyl sulfosuccinate sodium, sodium dodecyl sulfate, cetylpyridinium chloride (hexadecylpyridinium chloride), hexadecyltrimethylammonium bromide, sodium cholate, carbamoyl, choline chloride, sodium glycocholate, sodium taurodeoxycholate, lauric arginate, sodium stearoyl lactylate, sodium taurocholate, lecithins, sucrose oleate esters, sucrose stearate esters, sucrose palmitate esters, sucrose laurate esters, and other emulsifiers, and the like.

Suitable flavonoid additives are classified as flavonols, flavones, flavanones, flavan-3-ols, isoflavones, or anthocyanidins. Non-limiting examples of flavonoid additives include, but are not limited to, catechins (e.g., green tea extracts such as Polyphenon™ 60, Polyphenon™ 30, and Polyphenon™ 25 (Mitsui Norin Co., Ltd., Japan), polyphenols, rutins (e.g., enzyme modified rutin Sanmelin™ AO (San-fi Gen F.F.I., Inc., Osaka, Japan)), neohesperidin, naringin, neohesperidin dihydrochalcone, and the like.

Suitable alcohol additives include, but are not limited to, ethanol. In particular embodiments, the alcohol additive is present in the sweetener composition in an amount effective to provide a concentration from about 625 ppm to about 10,000 ppm when present in a consumable, such as, for example, a beverage.

Suitable astringent compound additives include, but are not limited to, tannic acid, europium chloride (EuCl₃), gadolinium chloride (GdCl₃), terbium chloride (TbCl₃), alum, tannic acid, and polyphenols (e.g., tea polyphenols). The astringent additive is present in the sweetener composition in an amount effective to provide a concentration from about 10 ppm to about 5,000 ppm when present in a consumable, such as, for example, a beverage.

Functional ingredients include, but are not limited to, saponins, antioxidants, dietary fiber sources, fatty acids, vitamins, glucosamine, minerals, preservatives, hydration agents, probiotics, prebiotics, weight management agents, osteoporosis management agents, phytoestrogens, long chain primary aliphatic saturated alcohols, phytosterols and combinations thereof.

Examples of suitable antioxidants for embodiments of this invention include, but are not limited to, vitamins, vitamin cofactors, minerals, hormones, carotenoids, carotenoid terpenoids, non-carotenoid terpenoids, flavonoids, flavonoid polyphenolics (e.g., bioflavonoids), flavonols, flavones, phenols, polyphenols, esters of phenols, esters of polyphenols, nonflavonoid phenolics, isothiocyanates, and combinations thereof. In some embodiments, the antioxidant is vitamin A, vitamin C, vitamin E, ubiquinone, mineral selenium, manganese, melatonin, α-carotene, β-carotene, lycopene, lutein, zeanthin, crypoxanthin, reservatol, eugenol, quercetin, catechin, gossypol, hesperetin, curcumin, ferulic acid, thymol, hydroxytyrosol, tumeric, thyme, olive oil, lipoic acid, glutathinone, gutamine, oxalic acid, tocopherol-derived compounds, butylated hydroxyanisole (BHA), butylated hydroxytoluene (BHT), ethylenediaminetetraacetic acid (EDTA), tert-butylhydroquinone, acetic acid, pectin, tocotrienol, tocopherol, coenzyme Q10, zeaxanthin, astaxanthin, canthaxantin, saponins, limonoids, kaempfedrol, myricetin, isorhamnetin, proanthocyanidins, quercetin, rutin, luteolin, apigenin, tangeritin, hesperetin, naringenin, erodictyol, flavan-3-ols (e.g., anthocyanidins), gallocatechins, epicatechin and its gallate forms, epigallocatechin and its gallate forms (ECGC) theaflavin and its gallate forms, thearubigins, isoflavone, phytoestrogens, genistein, daidzein, glycitein, anythocyanins, cyaniding, delphinidin, malvidin, pelargonidin, peonidin, petunidin, ellagic acid, gallic acid, salicylic acid, rosmarinic acid, cinnamic acid and its derivatives (e.g., ferulic acid), chlorogenic acid, chicoric acid, gallotannins, ellagitannins, anthoxanthins, betacyanins and other plant pigments, silymarin, citric acid, lignan, antinutrients, bilirubin, uric acid, R-α-lipoic acid, N-acetylcysteine, emblicanin, apple extract, apple skin extract (applephenon), rooibos extract red, rooibos extract, green, hawthorn berry extract, red raspberry extract, green coffee antioxidant (GCA), aronia extract 20%, grape seed extract (VinOseed), cocoa extract, hops extract, mangosteen extract, mangosteen hull extract, cranberry extract, pomegranate extract, pomegranate hull extract, pomegranate seed extract, hawthorn berry extract, pomella pomegranate extract, cinnamon bark extract, grape skin extract, bilberry extract, pine bark extract, pycnogenol, elderberry extract, mulberry root extract, wolfberry (gogi) extract, blackberry extract, blueberry extract, blueberry leaf extract, raspberry extract, turmeric extract, citrus bioflavonoids, black currant, ginger, acai powder, green coffee bean extract, green tea extract, and phytic acid, or combinations thereof. In alternate embodiments, the antioxidant is a synthetic antioxidant such as butylated hydroxytolune or butylated hydroxyanisole, for example. Other sources of suitable antioxidants for embodiments of this invention include, but are not limited to, fruits, vegetables, tea, cocoa, chocolate, spices, herbs, rice, organ meats from livestock, yeast, whole grains, or cereal grains.

Particular antioxidants belong to the class of phytonutrients called polyphenols (also known as “polyphenolics”), which are a group of chemical substances found in plants, characterized by the presence of more than one phenol group per molecule. Suitable polyphenols for embodiments of this invention include catechins, proanthocyanidins, procyanidins, anthocyanins, quercerin, rutin, reservatrol, isoflavones, curcumin, punicalagin, ellagitannin, hesperidin, naringin, citrus flavonoids, chlorogenic acid, other similar materials, and combinations thereof.

In particular embodiments, the antioxidant is a catechin such as, for example, epigallocatechin gallate (EGCG). Suitable sources of catechins for embodiments of this invention include, but are not limited to, green tea, white tea, black tea, oolong tea, chocolate, cocoa, red wine, grape seed, red grape skin, purple grape skin, red grape juice, purple grape juice, berries, pycnogenol, and red apple peel.

In some embodiments, the antioxidant is chosen from proanthocyanidins, procyanidins or combinations thereof. Suitable sources of proanthocyanidins and procyanidins for embodiments of this invention include, but are not limited to, red grapes, purple grapes, cocoa, chocolate, grape seeds, red wine, cacao beans, cranberry, apple peel, plum, blueberry, black currants, choke berry, green tea, sorghum, cinnamon, barley, red kidney bean, pinto bean, hops, almonds, hazelnuts, pecans, pistachio, pycnogenol, and colorful berries.

In particular embodiments, the antioxidant is an anthocyanin. Suitable sources of anthocyanins for embodiments of this invention include, but are not limited to, red berries, blueberries, bilberry, cranberry, raspberry, cherry, pomegranate, strawberry, elderberry, choke berry, red grape skin, purple grape skin, grape seed, red wine, black currant, red currant, cocoa, plum, apple peel, peach, red pear, red cabbage, red onion, red orange, and blackberries.

In some embodiments, the antioxidant is chosen from quercetin, rutin or combinations thereof. Suitable sources of quercetin and rutin for embodiments of this invention include, but are not limited to, red apples, onions, kale, bog whortleberry, lingonberrys, chokeberry, cranberry, blackberry, blueberry, strawberry, raspberry, black currant, green tea, black tea, plum, apricot, parsley, leek, broccoli, chili pepper, berry wine, and ginkgo.

In some embodiments, the antioxidant is reservatrol. Suitable sources of reservatrol for embodiments of this invention include, but are not limited to, red grapes, peanuts, cranberry, blueberry, bilberry, mulberry, Japanese Itadori tea, and red wine.

In particular embodiments, the antioxidant is an isoflavone. Suitable sources of isoflavones for embodiments of this invention include, but are not limited to, soy beans, soy products, legumes, alfalfa sprouts, chickpeas, peanuts, and red clover.

In some embodiments, the antioxidant is curcumin. Suitable sources of curcumin for embodiments of this invention include, but are not limited to, turmeric and mustard.

In particular embodiments, the antioxidant is chosen from punicalagin, ellagitannin or combinations thereof. Suitable sources of punicalagin and ellagitannin for embodiments of this invention include, but are not limited to, pomegranate, raspberry, strawberry, walnut, and oak-aged red wine.

In some embodiments, the antioxidant is a citrus flavonoid, such as hesperidin or naringin. Suitable sources of citrus flavonoids, such as hesperidin or naringin, for embodiments of this invention include, but are not limited to, oranges, grapefruits, and citrus juices.

In particular embodiments, the antioxidant is chlorogenic acid. Suitable sources of chlorogenic acid for embodiments of this invention include, but are not limited to, green coffee, yerba mate, red wine, grape seed, red grape skin, purple grape skin, red grape juice, purple grape juice, apple juice, cranberry, pomegranate, blueberry, strawberry, sunflower, Echinacea, pycnogenol, and apple peel.

Suitable dietary fibers include, but are not limited to, non-starch polysaccharides, lignin, cellulose, methylcellulose, the hemicelluloses, β-glucans, pectins, gums, mucilage, waxes, inulins, oligosaccharides, fructooligosaccharides, cyclodextrins, chitins, and combinations thereof.

Food sources of dietary fiber include, but are not limited to, grains, legumes, fruits, and vegetables. Grains providing dietary fiber include, but are not limited to, oats, rye, barley, wheat. Legumes providing fiber include, but are not limited to, peas and beans such as soybeans. Fruits and vegetables providing a source of fiber include, but are not limited to, apples, oranges, pears, bananas, berries, tomatoes, green beans, broccoli, cauliflower, carrots, potatoes, celery. Plant foods such as bran, nuts, and seeds (such as flax seeds) are also sources of dietary fiber. Parts of plants providing dietary fiber include, but are not limited to, the stems, roots, leaves, seeds, pulp, and skin.

Fatty acids any straight chain monocarboxylic acid and includes saturated fatty acids, unsaturated fatty acids, long chain fatty acids, medium chain fatty acids, short chain fatty acids, fatty acid precursors (including omega-9 fatty acid precursors), and esterified fatty acids. As used herein, “long chain polyunsaturated fatty acid” refers to any polyunsaturated carboxylic acid or organic acid with a long aliphatic tail. Suitable omega-3 fatty acids include, but are not limited to, linolenic acid, alpha-linolenic acid, eicosapentaenoic acid, docosahexaenoic acid, stearidonic acid, eicosatetraenoic acid and combinations thereof. Suitable omega-6 fatty acids include, but are not limited to, linoleic acid, gamma-linolenic acid, dihommo-gamma-linolenic acid, arachidonic acid, eicosadienoic acid, docosadienoic acid, adrenic acid, docosapentaenoic acid and combinations thereof. Suitable esterified fatty acids for embodiments of the present invention include, but are not limited to, monoacylgycerols containing omega-3 and/or omega-6 fatty acids, diacylgycerols containing omega-3 and/or omega-6 fatty acids, or triacylgycerols containing omega-3 and/or omega-6 fatty acids and combinations thereof.

Suitable vitamins include, vitamin A, vitamin D, vitamin E, vitamin K, vitamin B1, vitamin B2, vitamin B3, vitamin B5, vitamin B6, vitamin B7, vitamin B9, vitamin B12, and vitamin C. Various other compounds have been classified as vitamins by some authorities. These compounds may be termed pseudo-vitamins and include, but are not limited to, compounds such as ubiquinone (coenzyme Q10), pangamic acid, dimethylglycine, taestrile, amygdaline, flavanoids, para-aminobenzoic acid, adenine, adenylic acid, and s-methylmethionine. As used herein, the term vitamin includes pseudo-vitamins.

Minerals are selected from bulk minerals, trace minerals or combinations thereof. Non-limiting examples of bulk minerals include calcium, chlorine, magnesium, phosphorous, potassium, sodium, and sulfur. Non-limiting examples of trace minerals include chromium, cobalt, copper, fluorine, iron, manganese, molybdenum, selenium, zinc, and iodine. Although iodine generally is classified as a trace mineral, it is required in larger quantities than other trace minerals and often is categorized as a bulk mineral.

In other particular embodiments of this invention, the mineral is a trace mineral, believed to be necessary for human nutrition, non-limiting examples of which include bismuth, boron, lithium, nickel, rubidium, silicon, strontium, tellurium, tin, titanium, tungsten, and vanadium.

Preservatives are selected from antimicrobials, antioxidants, antienzymatics or combinations thereof. Non-limiting examples of antimicrobials include sulfites, propionates, benzoates, sorbates, nitrates, nitrites, bacteriocins, salts, sugars, acetic acid, dimethyl dicarbonate (DMDC), ethanol, and ozone. Sulfites include, but are not limited to, sulfur dioxide, sodium bisulfite, and potassium hydrogen sulfite. Propionates include, but are not limited to, propionic acid, calcium propionate, and sodium propionate. Benzoates include, but are not limited to, sodium benzoate and benzoic acid. Sorbates include, but are not limited to, potassium sorbate, sodium sorbate, calcium sorbate, and sorbic acid. Nitrates and nitrites include, but are not limited to, sodium nitrate and sodium nitrite. In yet another particular embodiment, the at least one preservative is a bacteriocin, such as, for example, nisin. In another particular embodiment, the preservative is ethanol. In still another particular embodiment, the preservative is ozone. Antienzymatics suitable for use as preservatives in particular embodiments of the invention include ascorbic acid, citric acid, and metal chelating agents such as ethylenediaminetetraacetic acid (EDTA).

Hydration products can be electrolytes, non-limiting examples of which include sodium, potassium, calcium, magnesium, chloride, phosphate, bicarbonate, and combinations thereof. Suitable electrolytes for use in particular embodiments of this invention are also described in U.S. Pat. No. 5,681,569, the disclosure of which is expressly incorporated herein by reference. Non-limiting examples of salts for use in particular embodiments include chlorides, carbonates, sulfates, acetates, bicarbonates, citrates, phosphates, hydrogen phosphates, tartrates, sorbates, citrates, benzoates, or combinations thereof. In particular embodiments of this invention, the hydration product is a carbohydrate to supplement energy stores burned by muscles. Suitable carbohydrates for use in particular embodiments of this invention are described in U.S. Pat. Nos. 4,312,856, 4,853,237, 5,681,569, and 6,989,171, the disclosures of which are expressly incorporated herein by reference. Non-limiting examples of suitable carbohydrates include monosaccharides, disaccharides, oligosaccharides, complex polysaccharides or combinations thereof. Non-limiting examples of suitable types of monosaccharides for use in particular embodiments include trioses, tetroses, pentoses, hexoses, heptoses, octoses, and nonoses. Non-limiting examples of specific types of suitable monosaccharides include glyceraldehyde, dihydroxyacetone, erythrose, threose, erythrulose, arabinose, lyxose, ribose, xylose, ribulose, xylulose, allose, altrose, galactose, glucose, gulose, idose, mannose, talose, fructose, psicose, sorbose, tagatose, mannoheptulose, sedoheltulose, octolose, and sialose. Non-limiting examples of suitable disaccharides include sucrose, lactose, and maltose. Non-limiting examples of suitable oligosaccharides include saccharose, maltotriose, and maltodextrin. In other particular embodiments, the carbohydrates are provided by a corn syrup, a beet sugar, a cane sugar, a juice, or a tea. In another particular embodiment, the hydration is a flavanol that provides cellular rehydration. Non-limiting examples of suitable flavanols for use in particular embodiments of this invention include catechin, epicatechin, gallocatechin, epigallocatechin, epicatechin gallate, epigallocatechin 3-gallate, theaflavin, theaflavin 3-gallate, theaflavin 3′-gallate, theaflavin 3,3′ gallate, thearubigin or combinations thereof. In a particular embodiment, the hydration product is a glycerol solution to enhance exercise endurance.

Probiotics comprise microorganisms that benefit health when consumed in an effective amount. Probiotics may include, without limitation, bacteria, yeasts, and fungi. Examples of probiotics include, but are not limited to, bacteria of the genus Lactobacilli, Bifidobacteria, Streptococci, or combinations thereof. In particular embodiments of the invention, the at least one probiotic is chosen from the genus Lactobacilli. Lactobacilli (i.e., bacteria of the genus Lactobacillus, hereinafter “L.”). Non-limiting examples of species of Lactobacilli found in the human intestinal tract include L. acidophilus, L. casei, L. fermentum, L. saliva roes, L. brevis, L. leichmannii, L. plantarum, L. cellobiosus, L. reuteri, L. rhamnosus, L. GG, L. bulgaricus, and L. thermophilus. According to other particular embodiments of this invention, the probiotic is chosen from the genus Bifidobacteria. Non-limiting species of Bifidobacteria found in the human gastrointestinal tract include B. angulatum, B. animalis, B. asteroides, B. bifidum, B. bourn, B. breve, B. catenulatum, B. choerinum, B. coryneforme, B. cuniculi, B. dentium, B. gallicum, B. gallinarum, B indicum, B. longum, B. magnum, B. merycicum, B. minimum, B. pseudocatenulatum, B. pseudolongum, B. psychraerophilum, B. pullorum, B. ruminantium, B. saeculare, B. scardovii, B. simiae, B. subtile, B. thermacidophilum, B. thermophilum, B. urinalis, and B. sp. According to other particular embodiments of this invention, the probiotic is chosen from the genus Streptococcus. Streptococcus thermophilus is a gram-positive facultative anaerobe. Other non-limiting probiotic species of this bacteria include Streptococcus salivarus and Streptococcus cremoris.

Prebiotics are compositions that promote the growth of beneficial bacteria in the intestines. Prebiotics include, without limitation, mucopolysaccharides, oligosaccharides, polysaccharides, amino acids, vitamins, nutrient precursors, proteins and combinations thereof. According to a particular embodiment of this invention, the prebiotic is chosen from dietary fibers, including, without limitation, polysaccharides and oligosaccharides. Non-limiting examples of oligosaccharides that are categorized as prebiotics in accordance with particular embodiments of this invention include fructooligosaccharides, inulins, isomalto-oligosaccharides, lactilol, lactosucrose, lactulose, pyrodextrins, soy oligosaccharides, transgalacto-oligosaccharides, and xylo-oligosaccharides. According to other particular embodiments of the invention, the prebiotic is an amino acid.

As used herein, “a weight management agent” includes an appetite suppressant and/or a thermogenesis agent. As used herein, the phrases “appetite suppressant”, “appetite satiation compositions”, “satiety agents”, and “satiety ingredients” are synonymous. The phrase “appetite suppressant” describes macronutrients, herbal extracts, exogenous hormones, anorectics, anorexigenics, pharmaceutical drugs, and combinations thereof, that when delivered in an effective amount, suppress, inhibit, reduce, or otherwise curtail a person's appetite. The phrase “thermogenesis agent” describes macronutrients, herbal extracts, exogenous hormones, anorectics, anorexigenics, pharmaceutical drugs, and combinations thereof, that when delivered in an effective amount, activate or otherwise enhance a person's thermogenesis or metabolism.

Suitable weight management agents include macronutrients selected from the group consisting of proteins, carbohydrates, dietary fats, and combinations thereof. Carbohydrates generally comprise sugars, starches, cellulose and gums that the body converts into glucose for energy. Non-limiting examples of carbohydrates include polydextrose; inulin; monosaccharide-derived polyols such as erythritol, mannitol, xylitol, and sorbitol; disaccharide-derived alcohols such as isomalt, lactitol, and maltitol; and hydrogenated starch hydrolysates. Carbohydrates are described in more detail herein below. Dietary fats are lipids comprising combinations of saturated and unsaturated fatty acids. Polyunsaturated fatty acids have been shown to have a greater satiating power than mono-unsaturated fatty acids. Accordingly, the dietary fats embodied herein desirably comprise poly-unsaturated fatty acids, non-limiting examples of which include triacylglycerols.

In a particular embodiment, the weight management agents is an herbal extract. Non-limiting examples of plants whose extracts have appetite suppressant properties include plants of the genus Hoodia, Trichocaulon, Caralluma, Stapelia, Orbea, Asclepias, and Camelia. Other embodiments include extracts derived from Gymnema Sylvestre, Kola Nut, Citrus Auran tium, Yerba Mate, Griffonia Simplicifolia, Guarana, myrrh, guggul Lipid, and black current seed oil. In a particular embodiment, the herbal extract is derived from a plant of the genus Hoodia, species of which include H. alstonii, H. currorii, H. dregei, H. flava, H. gordonii, H. jutatae, H. mossamedensis, H. officinalis, H. parviflorai, H. pedicellata, H. pilifera, H. ruschii, and H. triebneri. Hoodia plants are stem succulents native to southern Africa. In another particular embodiment, the herbal extract is derived from a plant of the genus Caralluma, species of which include C. indica, C. fimbriata, C. attenuate, C. tuberculata, C. edulis, C. adscendens, C. stalagmifera, C. umbellate, C. penicillata, C. russeliana, C. retrospicens, C. Arabica, and C. lasiantha. Carralluma plants belong to the same Subfamily as Hoodia, Asclepiadaceae. In another particular embodiment, the at least one herbal extract is derived from a plant of the genus Trichocaulon. Trichocaulon plants are succulents that generally are native to southern Africa, similar to Hoodia, and include the species T. piliferum and T. officinale. In another particular embodiment, the herbal extract is derived from a plant of the genus Stapelia or Orbea, species of which include S. gigantean and O. variegate, respectively. Both Stapelia and Orbea plants belong to the same Subfamily as Hoodia, Asclepiadaceae. In another particular embodiment, the herbal extract is derived from a plant of the genus Asclepias. Asclepias plants also belong to the Asclepiadaceae family of plants. Non-limiting examples of Asclepias plants include A. incarnate, A. curassayica, A. syriaca, and A. tuberose. Not wishing to be bound by any theory, it is believed that the extracts comprise steroidal compounds, such as pregnane glycosides and pregnane aglycone, having appetite suppressant effects. In a particular embodiment, the weight management agent is an exogenous hormone having a weight management effect. Non-limiting examples of such hormones include CCK, peptide YY, ghrelin, bombesin and gastrin-releasing peptide (GRP), enterostatin, apolipoprotein A-IV, GLP-1, amylin, somastatin, and leptin.

In certain embodiments, the osteoporosis management agent is at least one calcium source, i.e. any compound containing calcium, including salt complexes, solubilized species, and other forms of calcium. Non-limiting examples of calcium sources include amino acid chelated calcium, calcium carbonate, calcium oxide, calcium hydroxide, calcium sulfate, calcium chloride, calcium phosphate, calcium hydrogen phosphate, calcium dihydrogen phosphate, calcium citrate, calcium malate, calcium citrate malate, calcium gluconate, calcium tartrate, calcium lactate, solubilized species thereof, and combinations thereof. According to a particular embodiment, the osteoporosis management agent is a magnesium source, i.e. any compound containing magnesium, including salt complexes, solubilized species, and other forms of magnesium. Non-limiting examples of magnesium sources include magnesium chloride, magnesium citrate, magnesium gluceptate, magnesium gluconate, magnesium lactate, magnesium hydroxide, magnesium picolate, magnesium sulfate, solubilized species thereof, and mixtures thereof. In another particular embodiment, the magnesium source comprises an amino acid chelated or creatine chelated magnesium. In other embodiments, the osteoporosis agent is chosen from vitamins D, C, K, their precursors and/or beta-carotene and combinations thereof.

Numerous plants and plant extracts also have been identified as being effective in the prevention and treatment of osteoporosis. Not wishing to be bound by any theory, it is believed that the plants and plant extracts stimulates bone morphogenic proteins and/or inhibits bone resorption, thereby stimulating bone regeneration and strength. Non-limiting examples of suitable plants and plant extracts as osteoporosis management agents include species of the genus Taraxacum and Amelanchier, as disclosed in U.S. Patent Publication No. 2005/0106215, and species of the genus Lindera, Artemisia, Acorus, Carthamus, Carum, Cnidium, Curcuma, Cyperus, Juniperus, Prunus, Iris, Cichorium, Dodonaea, Epimedium, Erigonoum, Soya, Mentha, Ocimum, thymus, Tanacetum, Plantago, Spearmint, Bixa, Vitis, Rosemarinus, Rhus, and Anethum, as disclosed in U.S. Patent Publication No. 2005/0079232.

Examples of suitable phytoestrogens for embodiments of this invention include, but are not limited to, isoflavones, stilbenes, lignans, resorcyclic acid lactones, coumestans, coumestrol, equol, and combinations thereof. Isoflavones belong to the group of phytonutrients called polyphenols. In general, polyphenols (also known as “polyphenolics”), are a group of chemical substances found in plants, characterized by the presence of more than one phenol group per molecule. Suitable phytoestrogen isoflavones in accordance with embodiments of this invention include genistein, daidzein, glycitein, biochanin A, formononetin, their respective naturally occurring glycosides and glycoside conjugates, matairesinol, secoisolariciresinol, enterolactone, enterodiol, textured vegetable protein, and combinations thereof.

Long-chain primary aliphatic saturated alcohols are a diverse group of organic compounds. The term long-chain refers to the fact that the number of carbon atoms in these compounds is at least 8 carbons. Non-limiting examples of particular long-chain primary aliphatic saturated alcohols for use in particular embodiments of the invention include the 8 carbon atom 1-octanol, the 9 carbon 1-nonanol, the 10 carbon atom 1-decanol, the 12 carbon atom 1-dodecanol, the 14 carbon atom 1-tetradecanol, the 16 carbon atom 1-hexadecanol, the 18 carbon atom 1-octadecanol, the 20 carbon atom 1-eicosanol, the 22 carbon 1-docosanol, the 24 carbon 1-tetracosanol, the 26 carbon 1-hexacosanol, the 27 carbon 1-heptacosanol, the 28 carbon 1-octanosol, the 29 carbon 1-nonacosanol, the 30 carbon 1-triacontanol, the 32 carbon 1-dotriacontanol, and the 34 carbon 1-tetracontanol. In a particularly desirable embodiment of the invention, the long-chain primary aliphatic saturated alcohols are policosanol. Policosanol is the term for a mixture of long-chain primary aliphatic saturated alcohols composed primarily of 28 carbon 1-octanosol and 30 carbon 1-triacontanol, as well as other alcohols in lower concentrations such as 22 carbon 1-docosanol, 24 carbon 1-tetracosanol, 26 carbon 1-hexacosanol, 27 carbon 1-heptacosanol, 29 carbon 1-nonacosanol, 32 carbon 1-dotriacontanol, and 34 carbon 1-tetracontanol.

At least 44 naturally-occurring phytosterols have been discovered, and generally are derived from plants, such as corn, soy, wheat, and wood oils; however, they also may be produced synthetically to form compositions identical to those in nature or having properties similar to those of naturally-occurring phytosterols. According to particular embodiments of this invention, non-limiting examples of phytosterols well known to those or ordinary skill in the art include 4-desmethylsterols (e.g., β-sitosterol, campesterol, stigmasterol, brassicasterol, 22-dehydrobrassicasterol, and Δ5-avenasterol), 4-monomethyl sterols, and 4,4-dimethyl sterols (triterpene alcohols) (e.g., cycloartenol, 24-methylenecycloartanol, and cyclobranol).

According to particular embodiments of this invention, non-limiting examples of phytostanols include β-sitostanol, campestanol, cycloartanol, and saturated forms of other triterpene alcohols.

Both phytosterols and phytostanols, as used herein, include the various isomers such as the α and β isomers (e.g., α-sitosterol and β-sitostanol, which comprise one of the most effective phytosterols and phytostanols, respectively, for lowering serum cholesterol in mammals). he phytosterols and phytostanols of the present invention also may be in their ester form. Non-limiting examples of suitable phytosterol and phytostanol esters include sitosterol acetate, sitosterol oleate, stigmasterol oleate, and their corresponding phytostanol esters. The phytosterols and phytostanols of the present invention also may include their derivatives.

Generally, the amount of functional ingredient in the composition varies widely depending on the particular composition and the desired functional ingredient. Those of ordinary skill in the art will readily ascertain the appropriate amount of functional ingredient for each composition.

### EXAMPLES

### Example 1

Steviol glycosides with high purity (>95%) namely Rebaudioside A, B, D, M, Glycosylated steviol glycoside (GSG) were evaluated in acidified citric buffer, a lemon lime and a cola carbonated beverage at concentration of 480 ppm in finished beverage.

A. Lemon-Lime CSD

The following table shows the ingredients and their amount in the lemon lime syrup (5.5+1)

| Ingredients | Amount (%) |
|---|---|
| Filtered water | 98.05 |
| Citric acid | 0.76 |
| Sodium citrate | 0.178 |
| Sodium benzoate | 0.12 |
| Lemon lime flavor | 0.5655 |
| Steviol glycosides | 0.312 |
| GSG | 0.01625 |
| TOTAL | 100 |

The ingredients were dissolved in filtered water to constitute a syrup, then the final beverage was made by weighing the appropriate syrup amount and adding carbonated water using a ratio of 1-part syrup+5.5 parts carbonated water. Final beverages were filled in 300 ml glass bottles then aged for 3 days at 35° C. before they were cooled and served cold (4° C.). The control with Reb-M was made by heating water up to around 47° C. then dissolving Reb-M. After complete dissolution, the concentrated Reb-M solution was cooled down to ambient temperature before the rest of the ingredients were added. The other blends were soluble in syrup system and did not need any heating.

B. Cola CSD

The following table shows the ingredients and their amount in the cola syrup (5.5+1)

| Ingredients | Amount (%) |
|---|---|
| Filtered water | 98.06 |
| Caramel | 1.105 |
| Phosphoric acid | 0.13 |
| Citric acid | 0.065 |
| Potassium sorbate | 0.0585 |
| Sodium benzoate | 0.009 |
| Caffeine | 0.052 |
| Cola flavor | 0.195 |
| Steviol glycosides | 0.312 |
| GSG | 0.01625 |
| TOTAL | 100 |

The ingredients were dissolved in filtered water to constitute a syrup, then the final beverage was made by weighing the appropriate syrup amount and adding carbonated water using a ratio of 1-part syrup+5.5 parts carbonated water. Final beverages were filled in 300 ml glass bottles then aged for 3 days at 35° C. before they were cooled and served cold (4° C.). The control with Reb-M was made by heating water up to around 47° C. then dissolving Reb-M. After complete dissolution, the concentrated Reb-M solution was cooled down to ambient temperature before the rest of the ingredients were added. The other blends were soluble in syrup system and did not need any heating.

C. Sensory Evaluation

The beverages were evaluated blindly by at least 5 expert panelists who work and taste steviol glycosides sweetened beverages daily. Samples were coded and randomly presented to the panelists. Panelists were instructed to eat an unsalted cracker and rinse the mouth with water before and in between samples. The maximum samples for each session was set at 5 samples to avoid fatigue. For each sample, panelists were instructed to take 3 sips, then write down their evaluation comments. Mock beverages were tasted at ambient temperature while carbonated beverages (diet lemon lime and cola) were tasted at 4° C.

The following table shows the steviol glycosides in blends at different levels (ppm), the panelist ratings (1=most preferred, 6=least preferred) as well as the panelist comments.

| | | | Panelist Rating | |
|---|---|---|---|---|
| | Concentration | | (1 = most | |
| | (ppm) in | | preferred, | |
| Steviol Glycosides | Finished | GSG | 6 = least | |
| Blends | Beverage | (ppm) | preferred) | Panelists Comments |
| Reb-M | 480 ppm | — | 2 | Good upfront |
| | Not soluble at | | | sweetness, more |
| | syrup stage | | | sweetness lingering, |
| | | | | slightly bitter |
| Reb-A (170 ppm) + | 480 ppm | — | 6 | More bitterness |
| Reb-B (90 ppm) + | Soluble at | | | aftertaste, less sweet |
| Reb-D (30 ppm) + | syrup stage | | | compared with control |
| Reb-M (210 ppm) | | | | |
| Reb-A (170 ppm) + | 480 ppm | 20 ppm | 3 | Improved upfront |
| Reb-B (90 ppm) + | Soluble at | | | sweetness, no |
| Reb-D (30 ppm) + | syrup stage | | | bitterness. Some |
| Reb-M (210 ppm) | | | | panelists preferred it |
| | | | | over control Reb-M |
| Reb-A (135 ppm) + | 480 ppm | — | 5 | Some sweetness |
| Reb-B (85 ppm) + | Soluble at | | | lingering, slightly less |
| Reb-D (45 ppm) + | syrup stage | | | sweet than control |
| Reb-M (215 ppm) | | | | |
| Reb-A (135 ppm) + | 480 ppm | 25 ppm | 1 | Good sweetness, fast |
| Reb-B (85 ppm) + | Soluble at | | | upfront sweetness, |
| Reb-D (45 ppm) + | syrup stage | | | clean profile, good |
| Reb-M (215 ppm) | | | | balance, most |
| | | | | preferred by panelists |
| Reb-A (135 ppm) + | 480 ppm | 20 ppm | 4 | Balanced, good lemon |
| Reb-B (85 ppm) + | Soluble at | | | flavor, not much |
| Reb-D (45 ppm) + | syrup stage | | | lingering, slight bitter |
| Reb-M (215 ppm) | | | | aftertaste |

The sensory performance of the blends was significantly improved by the addition of GSG in both beverages. Overall, the blends were preferred over the control beverage with Reb-M and panelists stated that the blends did not show the sweetness lingering that was found with Reb-M. All the blends were unexpectedly soluble at syrup stage (at more than 0.3%) while Reb-M was not (0.1%).

### Example 2—Spray Drying and Solubility

### Lab Spray Dryers—Trial Run Details:

Temperature setting: 125-160° C., Spray Nozzle Air Pressure: 15-40 psi, Feed rate at 100 ml/hr to 1200 ml/hr.

### Sample Preparation and Solubility Data of High Solubility Stevia Blends:

20 wt % to 30 wt % of stevia blend slurry (compositions listed in Table below) was heated to 70° C.-100° C. (became clear solution) and spray dried to produce high solubility stevia blend samples using lab spray dryers. Solubility and sensory properties of the spray dried high solubility stevia blend samples were evaluated.

| | | | | | | | Diluted |
|---|---|---|---|---|---|---|---|
| | | | | | | Solu- | to |
| | | | | | Spray | bility | 5.4 + 1 |
| | Stevia Blend Composition | | | | drying | Test at | Throw |
| | Reb A | Reb B | Reb D | Reb M | Yield | 5 | conc.- |
| Sample | (%) | (%) | (%) | (%) | (%) | wt % | 0.325% |
| 1 | 28.12 | 17.71 | 9.38 | 44.79 | 96.5 | Clear | Clear |
| 2 | — | 31.25 | 12.5 | 56.25 | 96 | Clear | Clear |
| 3 | 31 | 18.0 | 9.0 | 42 | 96.8 | Clear | Clear |
| 4 | 28.13 | 17.7 | — | 54.17 | 97.2 | Clear | Clear |
| 5 | 32.3 | 17.7 | 20.83 | 33.33 | 96.5 | Clear | Clear |

1. A steviol glycoside blend selected from the group consisting of:
a. a quaternary steviol glycoside blend comprising from about 26% to about 35% rebaudioside A by weight, from about 40% to about 49% rebaudioside M by weight, from about 15% to about 25% rebaudioside B by weight and from about 5% to about 5% rebaudioside D by weight;
b. a ternary steviol glycoside blend comprising from about 26% to about 35% rebaudioside B by weight, from about 10% to about 15% rebaudioside D by weight and from about 55% to about 60% rebaudioside M by weight; and
c. a ternary steviol glycoside blend comprising from about 26% to about 35% rebaudioside A by weight, from about 15% to about 25% rebaudioside B by weight and from about 40% to about 60% rebaudioside M by weight.

2. The steviol glycoside blend of claim 1, wherein the steviol glycoside blend is soluble in water at concentrations from about 0.25 wt % to about 0.35 wt % at room temperature.

3. The steviol glycoside blend of claim 1, wherein the steviol glycoside blend has an aqueous solubility of at least about 3 wt % at room temperature.

4. A blend comprising a steviol glycoside blend of claim 1 and a composition comprising glycosylated steviol glycosides (GSG), wherein the blend provides superior sensory properties when formulated into a beverage compared to a corresponding beverage formulated without the composition comprising GSG.

5. A method for preparing spray-dried steviol glycoside blends of the present invention comprising
(i) heating a mixture comprising water and a steviol glycoside blend of claim 1 to a temperature between about 70° C. and about 100° C.,
(ii) maintaining the mixture at the temperature in (i) to provide a concentrated solution,
(iii) decreasing the temperature to not below about 70° C., and
(iv) spray-drying the concentrated solution while maintaining the feed temperature above about 70° C.

6. The method of claim 5, wherein the resulting blend has an aqueous solubility of at least about 3 wt %.

7. A beverage concentrate comprising (i) a steviol glycoside blend of claim 1 (ii) a composition comprising GSG, wherein the concentrate has a blend concentration of at least about 0.25 wt % and is clear by visual inspection.

8. A beverage comprising (i) a steviol glycoside blend of claim 1 and (ii) a composition comprising GSG, wherein the steviol glycoside concentration is from about 50 ppm to about 600 ppm and the composition comprising GSG concentration is from about 5 ppm to about 50 ppm.

9. The beverage of claim 8, wherein the beverage has a rebaudioside A concentration from about 120 ppm to about 170 ppm, a rebaudioside M concentration from about 190 ppm to about 240 ppm, a rebaudioside B concentration from about 70 ppm to about 120 ppm, a rebaudioside D concentration from about 20 ppm to about 75 ppm and a composition comprising GSG concentration from about 5 ppm to about 50 ppm.

10. The beverage of claim 8, wherein the beverage is a zero-calorie beverage.

11. The beverage of claim 8, wherein the beverage is a carbonated beverage.

12. The beverage of claim 8, wherein the beverage has a sucrose equivalence of at least about 8%.

13. The beverage of claim 8, wherein the beverage further comprises at least one sweetener, additive and/or functional ingredient.

14. The beverage of claim 8, wherein the steviol glycoside blend and composition comprising GSG provide all of the sucrose equivalence of the beverage.

15. The beverage of claim 8, wherein the beverage is a carbonated, zero-calorie beverage having a sucrose equivalence of at least about 8%.
